(19) United States
(12) Patent Application Publication
(10) Pub. No.: US 2020/0397201 A1
(43) Pub. Date: Dec. 24, 2020

(54) WASTE COLLECTION ATTACHMENT FOR VACUUM OF LEAF BLOWER AND METHOD OF USE

(71) Applicant: Marc Price, Prairie Village, KS (US)

(72) Inventor: Marc Price, Prairie Village, KS (US)

(21) Appl. No.: 16/906,868

(22) Filed: Jun. 19, 2020

Related U.S. Application Data
(60) Provisional application No. 62/921,449, filed on Jun. 19, 2019.

(51) Int. Cl. A47L 9/14

(52) U.S. Cl. CPC A47L 9/1427; A01G 20/47; A47L 9/149

(57) ABSTRACT

A waste collection device including a compartment for receiving pet waste or other waste. The device is attached to the end of a leaf blower, hand vacuum, or other device which provides suction. Accessories may be included which allow universal mounting to most or all types of vacuums and leaf blowers. A removable filter bag may be included for cleaner removal of waste.

### CROSS-REFERENCE TO RELATED APPLICATION

This application claims priority in U.S. Provisional Patent Application No. 62/921,449 filed Jun. 19, 2019 which is incorporated herein by reference.

### BACKGROUND OF THE INVENTION

### 1. Field of the Invention

The present invention relates generally to an attachment and method for use thereof, and more specifically to a waste collection attachment which can be used with a leaf blower, hand held vacuum, or any device which provides suction.

### 2. Description of the Related Art

Commonly, local laws, ordinances, or homeowners' associations require pet owners to remove and dispose of pet waste immediately or very soon after it is deposited. Even if a pet owner is not required by rule or regulation to remove pet waste, many pet owners prefer to remove it to maintain the cleanliness of their lawns, neighborhoods, and environment. Typically, pet waste is removed by using a bag, either with or without a shovel or scoop, to collect the waste. This activity requires the user to bend or stoop. This method is unpleasant and can result in the inadvertent transfer of waste to a user, which can be hazardous to the person's health. Further, because a plastic bag is often used, disposal can be environmentally detrimental.

Typically, devices for waste collection include shovels, scoops, bags, and other devices that require the user to have relatively good mobility and strength. Motorized devices are often heavy and/or bulky, difficult to transfer long distances, and require the user to have relatively good strength and flexibility. Even if the motorized devices are lighter in weight, each has its limitations. Commonly, motorized devices can be soiled during use and must be cleaned to eliminate undesirable odors and potential health risks from waste residue. Individuals that have arthritis, back pain, degenerative disc disease, coordination problems, poor eyesight, or other nerve or muscular problems that limit mobility can find cleaning up pet waste, debris, or other material by using such devices to be a particularly difficult task.

U.S. Pat. No. 10,022,026, which has the same inventor as the present application and is incorporated herein by reference, teaches a device aimed at picking up pet waste or other waste using suction. However, since most households already own an item which can provide vacuum suction such as a leaf blower or handheld vacuum, it may not be feasible to purchase an additional specialized device for the purposes of picking up waste. What is needed is a device which can provide the functionality of picking up waste such as pet waste while being usable with most or all existing vacuum-type devices.

Heretofore there has not been available a system or method for a waste collection device with the advantages and features of the present invention.

### BRIEF SUMMARY OF THE INVENTION

The present invention generally provides a waste collection device including a compartment for receiving pet waste or other waste. The device is attached to the end of a leaf blower, hand vacuum, or other device which provides suction. Accessories may be included which allow universal mounting to most or all types of vacuums and leaf blowers.

The leaf blower or vacuum device includes a motor and fan, along with other components, which provide air suction for drawing waste into the container. The leaf blower or vacuum may run on any common power type, from electricity to gasoline to solar energy. The vacuum or leaf blower may have a cord or be cordless and may have one-way suction or two-way blow/suction functionality.

In an embodiment affixed to a leaf blower, the leaf blower may have a telescopic tube or interlocking tubes which allow for extension of the distal end of the leaf blower. The compartment of the present invention could affix itself to any length of tube or simply to the end of the leaf blower itself for optimal universality.

By using this compartment with a vacuum device, including a leaf blower, the user's hands remain clean as the waste is deposited into the compartment. A bag or filter may be included within the compartment to capture the waste, adding an additional layer of security between the user and the waste. Clips or other means of retaining the bag or filter in position may be employed within or on the exterior of the compartment.

### BRIEF DESCRIPTION OF THE DRAWINGS

The drawings constitute a part of this specification and include exemplary embodiments of the present invention illustrating various objects and features thereof.

FIG. 1 is a three-dimensional diagram of a preferred embodiment of the present invention showing hidden features and elements in dashed lines.

FIG. 1A is a detailed three-dimensional diagram of a filter bag element thereof.

FIG. 2 is a three-dimensional diagram thereof showing the preferred embodiment of the present invention engaged in a typical environment of a hand-held vacuum using an attachment.

FIG. 3 is a three-dimensional diagram of the hand-held vacuum thereof.

FIG. 4 is a three-dimensional diagram of the attachment of FIG. 2.

FIG. 5 is a three-dimensional diagram of a typical environment consisting of a leaf blower.

FIG. 6 is a three-dimensional diagram thereof showing the leaf blower affixed to the preferred embodiment of the present invention of FIG. 1.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Waste Collection Attachment 2

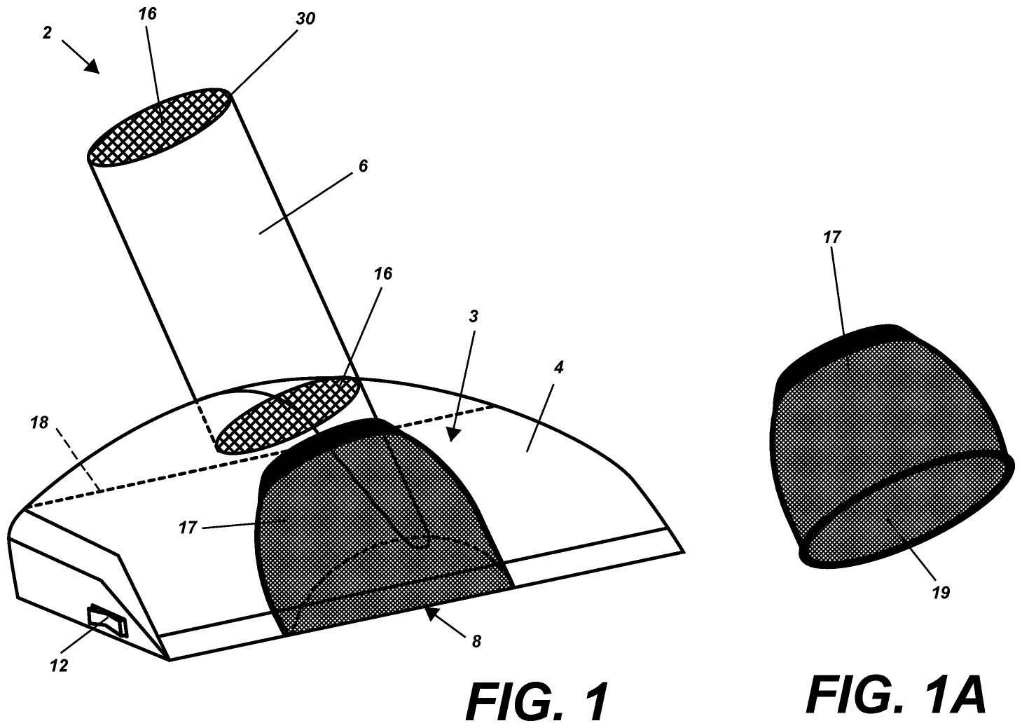

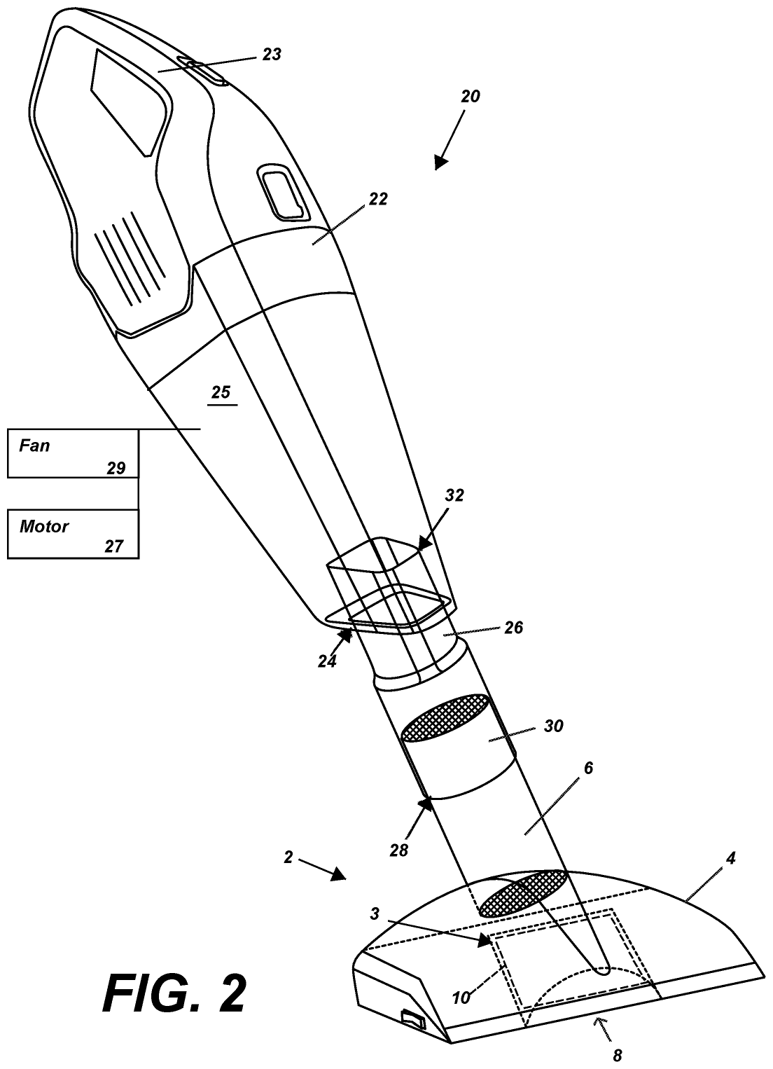

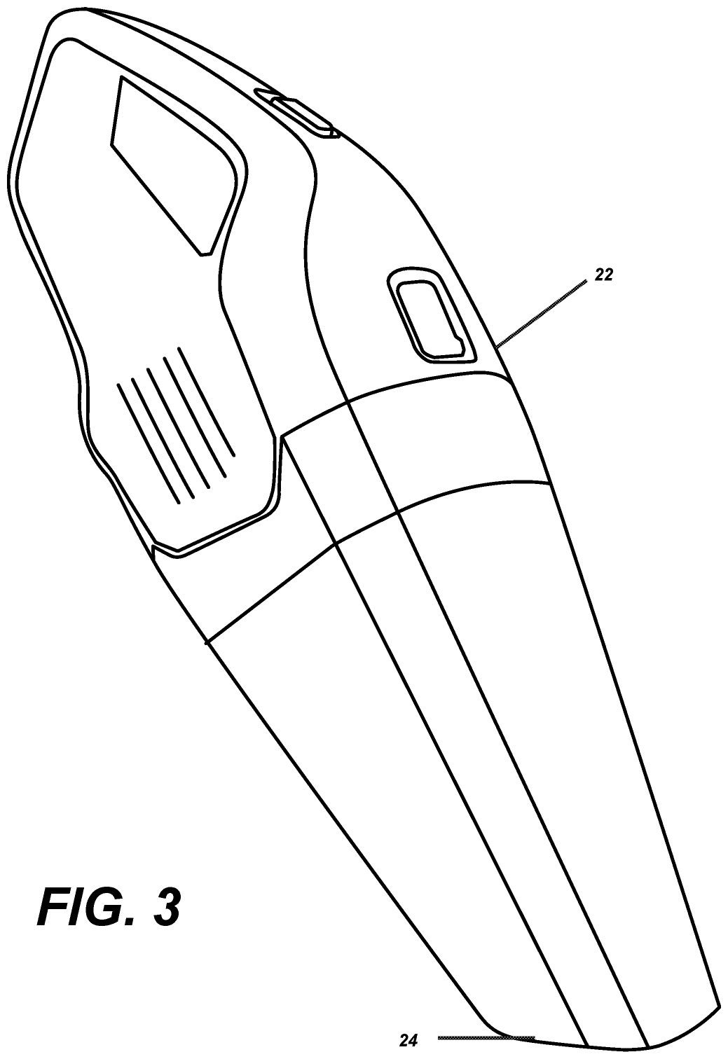

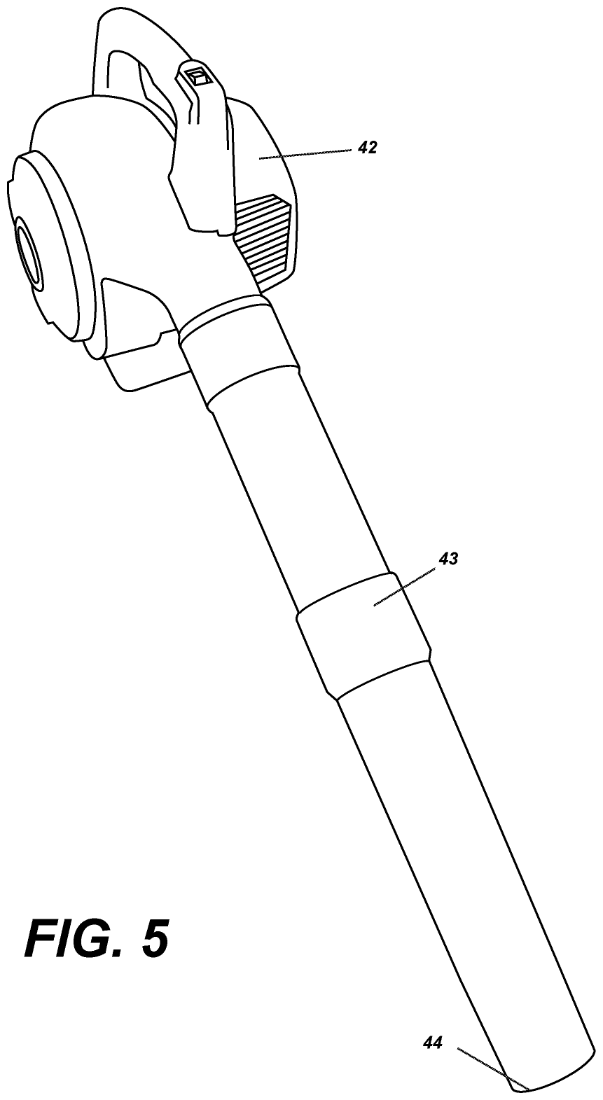

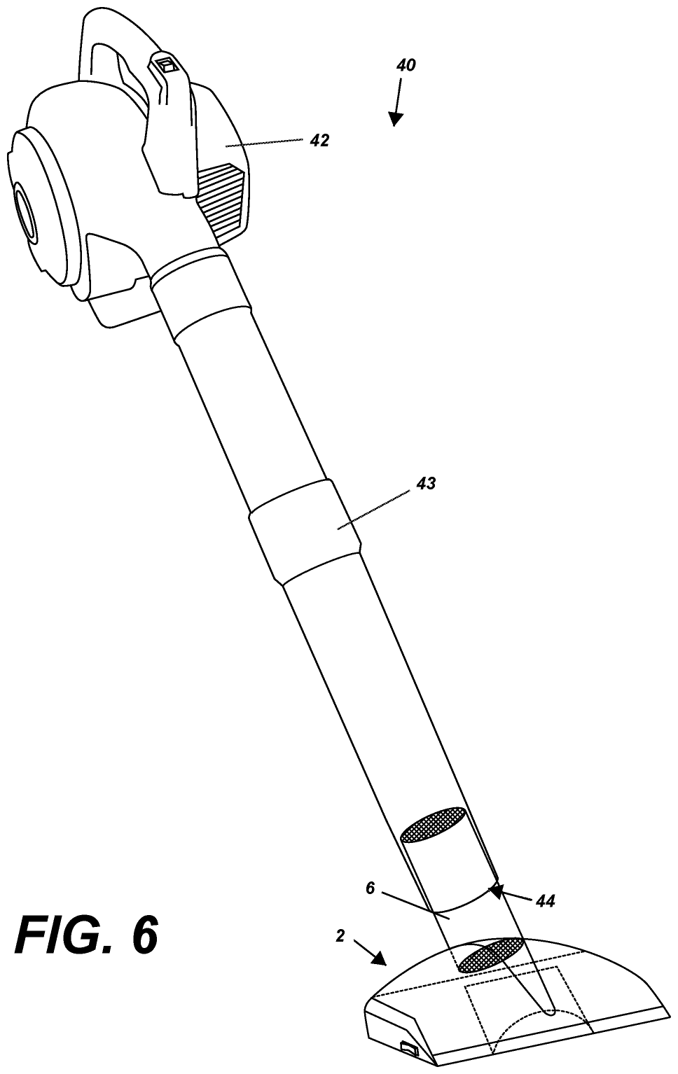

FIG. 1 shows a waste collection device 2 which has a base 4 housing an interior compartment 3, and a connector 6 for connecting the waste collection attachment 2 to a vacuum-capable device, such as a hand vacuum shown in FIGS. 2-3 or a leaf blower shown in FIGS. 5-6. Any suitable vacuum-capable device which has a motor 27, fan 29, housing 25, and handle 23 which, when attached to the waste collection device 2, makes it simple and easy to pick up waste such as pet waste. The base 4 could have lights, safety reflectors, or other features to aid the user in low-light areas.

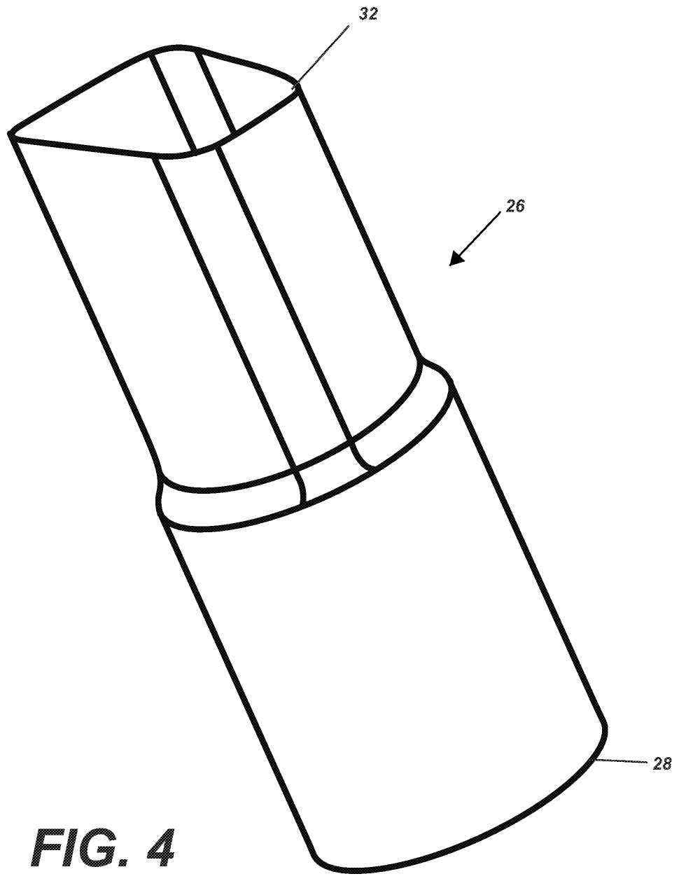

The waste collection device 2 has an opening 8 in the front of the base 4, a flap 10 for opening and cleaning the attachment, and an optional collection bag or filter 17 which further captures the waste and contains it for easy removal and cleaning. The bag or filter may also be disposable and thrown away. As shown in FIG. 1A, the filter/bag 17 has an opening 19 which receives the waste when it enters the base 4 through the opening 8. The entire base compartment front can be opened along a hinge 18 or other means of opening. A switch 12 can be used to lock or open the flap compartment. The connector 6 has a pair of mesh filter guard 16 for filters to prevent waste from being sucked into the vacuum device. The upper end 30 of the connector 6 connects to the vacuum device or an attachment which converts it for connecting to a vacuum device such as shown in FIG. 4.

As shown in FIG. 2, the waste collection device 2 can be connected to a hand vacuum 22 to form a waste collection vacuum 20. An attachment 26 connects the connector 6 to the end 24 of the vacuum 22. The upper end 32 of the attachment 26 is inserted into the end 24 of the vacuum as shown to secure it into place, and the lower end 28 of the attachment 26 connects to the upper end 30 of the connector 6. When the vacuum 22 is turned on, suction pulls waste into the opening 8 of the waste collection attachment 2 and is stored within the compartment base 4 or within an optional filter or bag 17. FIG. 3 shows the vacuum by itself. FIG. 4 shows the attachment 26 by itself. A number of attachments may be used to make the waste collection device 2 universally connectable to any vacuum device. Alternatively, the attachment 26 could have flexible or adjustable ends to fit vacuums and/or leaf blowers universally.

FIG. 5 shows a standard leaf blower 42 which has a tube 43 with a tube end 44. The tubes do not have to be connected to the leaf blower 42 for attachment to the waste collection device 2, but may be used to extend reach. The leaf blower 42 must be capable of performing suction.

FIG. 6 shows the leaf blower 42 connected to the waste collection device 2 by connecting the connector 6 to the end 44 of the tube 43, thereby creating a waste collection vacuum 40.

It is to be understood that while certain embodiments and/or aspects of the invention have been shown and described, the invention is not limited thereto and encompasses various other embodiments and aspects.

1. A portable vacuum system comprising:
a waste collection device comprising an opening, an interior compartment, and a connector having an open receiving end;
a portable vacuum device comprising a handle, a motor having a fan, and an open end configured for sucking waste and debris into said portable vacuum device;
said portable vacuum device open end configured to be temporarily connected to said open receiving end of said connector of said waste collection device;
said waste collection device configured to intake waste within said interior compartment via said opening when said portable vacuum device is operated; and
wherein said waste collection device and said portable vacuum device are selectively separable.

2. The portable vacuum system of claim 1, further comprising an attachment placed between said open receiving end of said waste collection device and said portable vacuum device open end, said attachment configured to connect said waste collection device to said portable vacuum device.

3. The portable vacuum system of claim 1, wherein said interior compartment is selectively openable along a hinge.

4. The portable vacuum system of claim 1, wherein said opening of said waste collection device comprises a flap.

5. The portable vacuum system of claim 1, further comprising a collection bag within said interior compartment, said collection bag configured to receive and store waste entering said waste collection device.

6. The portable vacuum system of claim 1, further comprising at least one filter guard located within said connector of said waste collection device.

7. A waste collection device for a portable vacuum device, the attachment device comprising:
an opening, an interior compartment, and a connector having an open receiving end;
said connector configured to connect the waste collection device to the portable vacuum device;
the waste collection device configured to intake waste within said interior compartment via said opening when said portable vacuum device is operated; and
wherein said waste collection device and said portable vacuum device are selectively separable.

8. The portable vacuum system of claim 7, further comprising an attachment placed between said open receiving end of said waste collection device and said portable vacuum device open end, said attachment configured to connect said waste collection device to said portable vacuum device.

9. The portable vacuum system of claim 7, wherein said interior compartment is selectively openable along a hinge.

10. The portable vacuum system of claim 7, wherein said opening of said waste collection device comprises a flap.

11. The portable vacuum system of claim 7, further comprising a collection bag within said interior compartment, said collection bag configured to receive and store waste entering said waste collection device.

12. The portable vacuum system of claim 7, further comprising at least one filter guard located within said connector of said waste collection device.

13. A portable waste collection system comprising:
a waste collection device comprising an opening, an interior compartment, and a connector having an open receiving end and at least one filter guard;
a portable vacuum device comprising a handle, a motor having a fan, and an open end configured for sucking waste and debris into said portable vacuum device;
said portable vacuum device open end located distally from said handle, and said open end configured to be temporarily connected to said open receiving end of said connector of said waste collection device;
said waste collection device configured to intake waste within said interior compartment via said opening when said portable vacuum device is operated;
wherein the vacuum device is operable with one hand; and
wherein said waste collection device and said portable vacuum device are selectively separable.

14. The portable vacuum system of claim 13, further comprising an attachment placed between said open receiving end of said waste collection device and said portable vacuum device open end, said attachment configured to connect said waste collection device to said portable vacuum device.

15. The portable vacuum system of claim 13, wherein said interior compartment is selectively openable along a hinge.

16. The portable vacuum system of claim 13, wherein said opening of said waste collection device comprises a flap.

17. The portable vacuum system of claim 13, further comprising a collection bag within said interior compartment, said collection bag configured to receive and store waste entering said waste collection device.

18. The portable vacuum system of claim 13, further comprising at least one filter guard located within said connector of said waste collection device.
